(19) United States
(12) Patent Application Publication
(10) Pub. No.: US 2009/0006480 A1
(43) Pub. Date: Jan. 1, 2009

(54) SYSTEM AND METHOD FOR PROVIDING EFFICIENT ACCESS TO DIGITAL MAP DATA

(75) Inventors: Gil Fuchs, Woodside, CA (US); Darrell L. Mathis, Hillsborough, CA (US)

Correspondence Address: FLIESLER MEYER LLP, 650 CALIFORNIA STREET, 14TH FLOOR, SAN FRANCISCO, CA, 94108, US

(73) Assignee: TELE ATLAS NORTH AMERICA, INC., Lebanon, NH (US)

(21) Appl. No.: 12/163,840

(22) Filed: Jun. 27, 2008

Related U.S. Application Data
(63) Continuation-in-part of application No. 11/466,034, filed on Aug. 21, 2006.
Application No. 11/466,034 is a continuation of application No. 10/209,750, filed on Jul. 31, 2002, now Pat. No. 7,103,854.
(60) Provisional application No. 60/947,344, filed on Jun. 29, 2007.
(60) Provisional application No. 60/947,369, filed on Jun. 29, 2007.
(60) Provisional application No. 60/947,626, filed on Jul. 2, 2007.
(60) Provisional application No. 60/392,742, filed on Jun. 27, 2002.

(51) Int. Cl. G06F 17/30

(52) U.S. Cl. 707/104.1; 707/E17.018

(57) ABSTRACT

A system and method for providing efficient access to digital map data. An embodiment of the present invention is generally related to systems for accessing, displaying, editing and using digital maps. In some map data formats each map item is not necessarily stored or encoded using a consistent byte length. Instead, to save overall storage requirements, the map items can be stored as different byte length variables. In accordance with an embodiment, the system comprises a bit stream processor that provides a staging area for efficient reading and writing of map data, and also provides security for adjoining data portions that use different byte length variables. An input map or map data can be read into the system, and optionally written to an output map. As map data is read into the system, instead of reading it directly from disk storage to the display screen, which takes time, the bit stream processor places the map data in memory and reads it from there. As map data is written to the system for storage or output, the bit stream processor can cache the map data in the cache, and write it from there.

### CLAIM OF PRIORITY

This application claims the benefit of priority to U.S. Provisional Patent Application titled “SYSTEM AND METHOD FOR GENERATING DIGITAL MAP INFORMATION FROM DIGITAL MAP DISPLAYS”; Application No. 60/947,344, filed Jun. 29, 2007; U.S. Provisional Patent Application titled “SYSTEM AND METHOD FOR GENERATING DIGITAL MAP INFORMATION FROM DIGITAL MAP DISPLAYS”; Application No. 60/947,369, filed Jun. 29, 2007; and U.S. Provisional Patent Application titled “SYSTEM AND METHOD FOR GENERATING DIGITAL MAP INFORMATION FROM DIGITAL MAP DISPLAYS”; Application No. 60/947,626, filed Jul. 2, 2007; this application is also a continuation-in-part of U.S. Patent Application titled “SYSTEM AND METHOD FOR ASSOCIATING TEXT AND GRAPHICAL VIEWS OF MAP INFORMATION”; application Ser. No. 11/466,034, filed Aug. 21, 2006, which is a continuation of U.S. Patent Application titled “SYSTEM AND METHOD FOR ASSOCIATING TEXT AND GRAPHICAL VIEWS OF MAP INFORMATION”; application Ser. No. 10/209,750, filed Jul. 31, 2002, now U.S. Pat. No. 7,103,854, issued on Sep. 5, 2006, which claims priority from U.S. Provisional Application titled “SYSTEM AND METHOD FOR ASSOCIATING TEXT AND GRAPHICAL VIEWS OF MAP INFORMATION”; Application No. 60/392,742, filed Jun. 27, 2002; all of which applications are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is related to systems for displaying, editing and using digital maps, and particularly to a system and method for converting digital map information, and generating digital map information from digital map displays.

### BACKGROUND

The use of digital geographic or map data has become commonplace in today's modern, computerized society. Commonly referred to as electronic maps, digital maps, digitized maps, or simply as maps, this geographic or map data can be used in a wide variety of applications. A typical application is in the travel industry, whereby digital maps are used to quickly and automatically chart travel routes, and to locate destinations. Digital maps have found a particularly common everyday use in automobiles, wherein Global Positioning Systems (GPS) are used in association with a digital map to automatically track the position of a car and display the position on a map, for instance to guide the driver to a particular destination.

Digital maps are often also used in commercial environments, for example in calculating optimized routes for delivery drivers to take when performing deliveries, or for providing accurate directions for emergency and medical crews to follow when responding to emergency calls. For many years, the digital map industry has also supplied maps to the military for use in military applications. Digital maps find a use in all aspects of commercial enterprise, including for ground-based, maritime, and aviation purposes. As people become more familiar in carrying handheld electronic and Personal Digital Assistant (PDA) devices, which are increasingly distributed together with digital maps stored therein, the electronic or digital map industry has also become familiar in consumer-oriented applications.

FIG. 1 shows a typical example of how a digital map is used by a software application to provide map and direction information to an operator. As shown in FIG. 1, a display screen 100 under control of the operator or user can be used to display a graphical window 102, and thereon a digital version of the map 104, i.e. a digital map. The operator may select any object or item within the map to find out information that item. A second window 106 can be used to provide map or object information. Information about the map and the items contained therein can be used to provide, for example, driving directions 108 to the operator from a first location to a second location.

To take advantage of the increased usage and functionality of digital maps, several different data formats or digital map formats have been developed. One example of these map formats is the Geographic Data File (GDF) map format co-developed by Tele Atlas, Inc., Navteq, Inc., and others. The GDF format is particularly useful for transferring map data between two or more systems. Since collecting the original map data is very time consuming, and must be performed to high accuracy of the data, it is sometimes desirable to be able to convert the data from one map format to another map format, so that the data need not be collected multiple times. Similarly it is sometimes desirable to make map data available in new formats that may be better suited for use in new applications. However, to date no current system allows for easy converting between different map formats.

Furthermore, along with this increased usage and functionality of electronic maps, the need has arisen to insure that these electronic maps are provided in such a way that they are flexible enough to allow for changes in the geography or in the political use of the underlying geographical area. For example, in urban areas the location and usage of surface streets may change on a regular basis. At street intersections, the direction of traffic flow, traffic restrictions, or turn lanes that are in place one day, might the very next day be reversed, removed, or changed in some other way. An electronic map that is several years old (or in some cases even several days old) is of lesser use in such an environment, because the image the map displays, and the information it provides, is no longer reliably related to the underlying geography. As such, electronic map vendors continuously seek new ways in which they can regularly update and check the accuracy of their electronic maps, and do so in an easy manner such that the map need not be created from scratch each time, but can instead be updated or derived from previous versions of the map to reflect the new geography. Such a process is akin to the debugging process familiar to software application developers who must strive to fix problems and errors in their underlying software code. However, traditional means of debugging map data tend to be tedious, time-consuming, and format-specific. The overall result of this is that electronic maps created and updated using traditional methods are relatively inflexible and pose a barrier which discourages map vendors from updating their maps on a regular basis.

### SUMMARY

In accordance with an embodiment, disclosed herein is a system and method for converting digital map information using displayable map information as an intermediary. An embodiment of the present invention is generally related to systems for accessing, displaying, editing and using digital maps. The system can receive data into the viewer application in a first map format and then provide or output that data in a second map format. Different map formats can be interpreted and/or optionally displayed in a universal display format. Depending on the particular embodiment the universal display format can include item coordinates, or higher level descriptions of geometry and topology in the map. In accordance with an embodiment, a map format legend associated with a particular map format can then be used to interpret the universal display format, and output the data into that map format. A plurality of different map legends can be used to allow different map formats to be output. In this manner the system allows for easy and universal converting of map formats.

In accordance with an embodiment, disclosed herein is a system and method for viewing and editing digital maps using plugin data abstraction layers for different digital map formats. An embodiment of the present invention is generally related to systems for displaying, editing and using digital maps. The system includes a viewer application together with a data abstraction layer and a plurality of different data abstraction interfaces. The data abstraction layer can be used to allow different map formats to be parsed and viewed. This allows the system to receive data in any of a variety of different input map formats. The map can then be edited, viewed, displayed on a display screen, or output. The map can also be used to create or display a map in a universal display format that is independent of the original format.

In accordance with an embodiment, disclosed herein is a system and method for using layers and grids to access, view, edit and store digital map data. An embodiment of the present invention is generally related to systems for displaying, editing and using digital maps. The system assists in previewing and outputting data to different map formats. Some maps include multiple levels of tiled map information. The map can be displayed on a display screen in a universal display format that is independent of the original format, and can then be parsed using a map legend. Features are provided to allow output of different types or sets of map data based on the currently displayed map. If a user modifies the map display to display a greater, or lesser, detail of resolution, then the set of map data that is output can be varied accordingly.

In accordance with an embodiment, disclosed herein is a system and method for providing efficient access to digital map data. An embodiment of the present invention is generally related to systems for accessing, displaying, editing and using digital maps. In some map data formats each map item is not necessarily stored or encoded using a consistent byte length. Instead, to save overall storage requirements, the map items can be stored as different byte length variables. In accordance with an embodiment, the system comprises a bit stream processor that provides a staging area for efficient reading and writing of map data, and also provides security for adjoining data portions that use different byte length variables. An input map or map data can be read into the system, and optionally written to an output map. As map data is read into the system, instead of reading it directly from disk storage to the display screen, which takes time, the bit stream processor places the map data in memory and reads it from there. As map data is written to the system for storage or output, the bit stream processor can cache the map data in the cache, and write it from there.

### DESCRIPTION OF THE DRAWINGS

FIG. 1 shows a typical example of how a digital map is used by a software application to provide map information to an operator.

FIG. 2 illustrates a screen display as it may be used by a user or operator to view and edit a digital map.

FIG. 3 illustrates how the operator can select from either the graphical view and from a variety of map items displayed therein, and display a text view which illustrates attributes associated with each item.

FIG. 4 illustrates how a semantic network can be used to provide a basis for map understanding.

FIG. 5 further illustrates how a semantic network can be used to provide a basis for map understanding.

FIG. 6 illustrates a schematic of an embodiment, in which the system allows for a variety of map formats to be retrieved, manipulated, viewed, and edited by an operator or user according to the above description.

FIG. 7 shows a screenshot of an embodiment that can be integrated or used with a viewer application to allow viewing and editing of digital maps.

FIG. 8 illustrates a schematic of an embodiment, in which the system is extensible to provide support for additional map formats.

FIG. 9 is a flowchart of a method for providing support for additional map formats.

FIG. 10 illustrates a schematic of an embodiment which allows for a variety of map formats to be retrieved, manipulated, viewed, edited, and converted into other map formats.

FIG. 11 illustrates a map legend cross-reference table in accordance with an embodiment.

FIG. 12 illustrates another schematic of one type of system that allows for a variety of map formats to be retrieved, manipulated, viewed, and edited.

FIG. 13 illustrates another schematic of one type of system that allows for a variety of map formats to be retrieved, manipulated, viewed, and edited.

FIG. 14 illustrates a flowchart that can be used with an embodiment, in which the system allows for a variety of map formats to be retrieved, manipulated, viewed, and edited by an operator or user.

FIG. 15 illustrates a schematic of an embodiment that allows for a preview of an output digital map format, such as a PSI format map, to be compared to an input map format, for use in converting between map formats.

FIG. 16 illustrates a schematic of another embodiment that allows for a preview of an output digital map format, such as a PSI format map, to be compared to an input map format, for use in converting between map formats.

FIG. 17 illustrates a flowchart that can be used with an embodiment, in which the system allows for an output digital map format, such as a PSI format map, to be compared to an input map format, for use in converting between map formats.

FIG. 18 shows a screenshot of an embodiment that can be integrated or used with a viewer application to allow viewing and editing of digital maps.

FIG. 19 shows another screenshot of an embodiment that can be integrated or used with a viewer application to allow viewing and editing of digital maps.

FIG. 20 illustrates multiple levels and tiles of information as stored in a multi-level map format (e.g. PSI).

FIG. 21 shows another screenshot of an embodiment that can be integrated or used with a viewer application to allow viewing and editing of digital maps.

FIG. 22 shows another screenshot of an embodiment that can be integrated or used with a viewer application to allow viewing and editing of digital maps.

FIG. 23 illustrates a flowchart that can be used with an embodiment, in which the system allows for levels of a particular map formats to be retrieved, manipulated, viewed, edited, and output by an operator.

FIG. 24 illustrates a schematic of an embodiment that allows for map data to be read, edited, and stored into the system.

FIGS. 25-28 illustrate screenshots of a viewer for displaying, previewing, and accessing levels of a multi-level digital map data.

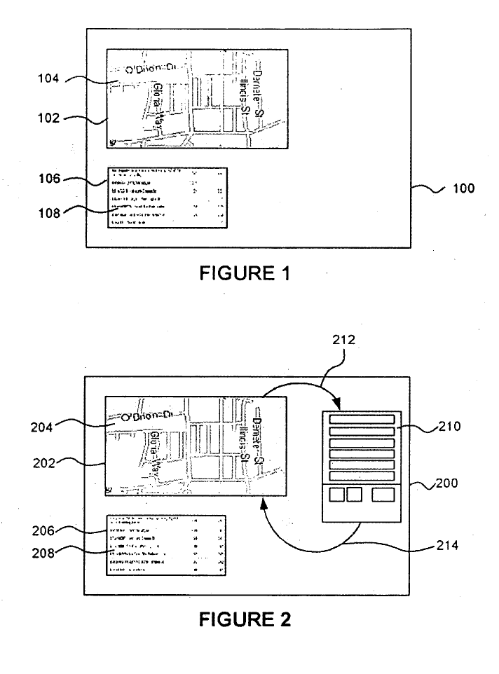

### DETAILED DESCRIPTION

Embodiments of the present invention are generally related to systems for displaying, editing and using digital maps, and particularly to systems and methods for generating digital map information from digital map displays, the use of data abstraction layers or interfaces to support multiple map formats, and the use of grids for efficient access to map data. Electronic or digital maps are nowadays provided in a variety of different map formats. One example of these map formats is the Geographic Data File (GDF) format co-developed by Tele Atlas, Inc. and Navteq, Inc. The GDF format is particularly useful for transferring map data between two or more systems. Another example of a digital map format is the Public Sector Information (PSI) format developed by a consortium of international companies from Europe, Japan, and the United States. Since collecting the original map data is time consuming, and must be performed with high accuracy, it is sometimes desirable to be able to convert the data from one map format to another map format, so that the data need not be collected multiple times. Similarly it is sometimes desirable to make map data available in new formats that may be better suited for use in new applications.

In accordance with an embodiment, the system includes a viewer application together with a data abstraction layer and a plurality of different data abstraction interfaces. The data abstraction layer can be used to allow different map formats (e.g. GDF or PSI) to be parsed and viewed. This allows the system to receive data in any of a variety of different input map formats. The map can then be edited, viewed, displayed on a display screen, or output. The map can also be used to create or display a map in a universal display format that is independent of the original format.

In accordance with another embodiment, the system is able to receive data into the viewer application in a first map format (e.g. GDF) and then provide or output that data in a second map format (e.g. PSI). As described above, a data abstraction layer and interfaces can be used to allow different map formats to be displayed in a universal display format. In accordance with an embodiment, a map format legend associated with a particular map format can then be used to interpret the universal display format, and output the data into that map format. A plurality of different map legends can be used to allow different map formats to be output. In this manner the system allows for easy and universal converting of map formats. The system also reduces the need for customized programming necessary to support those different formats from (M*N) convertors to M+N convertors (where M and N are the numbers of different input formats and different output formats respectively).

In accordance with another embodiment, techniques are provided that assist in debugging either the map data itself, or the conversion of the map data from one map format to another map format. Techniques are also provided that assist in previewing and outputting data to particular map formats, for example formats such as PSI that can include multiple levels of tiled map information. Since the map can be displayed on a display screen in a universal display format that is independent of the original format, and can then be parsed using a map legend, techniques can be used to output different types or sets of map data based on the currently displayed map. If a user modifies the map display to display a greater, or lesser, detail of resolution, then the set of map data that is output can also be varied accordingly.

### Digital Map Viewer

As described above, the use of digital geographic or map data has become commonplace in today's modern, computerized society. A typical application of digital maps is in the travel industry, whereby digital maps are used to quickly and automatically chart travel routes, and to locate destinations. Digital maps have found a particularly common everyday use in automobiles, wherein Global Positioning Systems (GPS) are used in association with a digital map to automatically track the position of a car and display the position on a map, for instance to guide the driver to a particular destination. Digital maps are used both in commercial environments, for example in calculating optimized routes for delivery drivers to take when performing deliveries, or for providing accurate directions for emergency and medical crews to follow when responding to emergency calls,; and in consumer-oriented environments, for example, to provide personal direction finding in Personal Digital Assistant (PDA) and other devices.

One aspect of the increasing use of digital map data is the fact that many different formats have been developed, by many different entities, to store, share, and use the map data. In some instances or applications certain map formats are more suitable or more efficient than other map formats. Some examples of how map data can be used, and the consequences of those uses include:

Data Transfer—Once collected, the original map data may need to be transferred from one entity to another, including between different companies or different industry partners. Map formats that are most suitable for data transfer have a clearly defined specification and fields.

Data Access—Depending on the application to which the map data may be used, issues such as speed of access to data items may be a factor. This may be particularly important in end-user or consumer-oriented applications.

Map Storage—Depending on the application to which the map data will be used, some formats may have less storage requirements than other formats.

Map Item Update—For a company that must regularly update its map data, the ability to quickly and easily modify map items is important.

Data Testing and Quality Control—For those companies that develop their own map databases and update map item information, a map format that can be easily debugged may be important.

Map Digitizing—Some map formats are better suited to the task of map digitization.

Data Gathering—Some map formats are better suited to the task of data gathering and storing data in the map itself.

As will be evident from the above list, the different uses to which map data is gathered, stored, shared, and used, will have a large impact on the ideal requirements of a particular map data format, and will determine the most suitable map format for that task. It is unlikely that any single map format can simultaneously address the need of every application to which that map data could be put to use. To minimize the need to have to recreate the map data for each format, techniques that can allow a company to easily interoperate between multiple map formats are desirable.

Generally described, embodiments of the invention can be used to provide a means such as a viewer or editor application by which an operator can view, verify, edit, and convert electronic or digital map data from one format to another. A computer is used to allow the operator perform this task, by providing a mechanism by which maps of various different formats can be retrieved into the memory of the computer and on which the map viewer or map editor software application runs. A primary purpose of the viewer/editor is in industrialized or commercial map development applications. The system can be provided to allow operators to maintain the accuracy of map data, for example by updating the maps to reflect changes to the underlining geography, and converting maps from one map format to another for use in particular commercial applications.

Embodiments of the invention can also be used in everyday or consumer-oriented usage, for example integrated into portable or handheld electronic devices, or in navigation devices, where the operator wishes to access map data in a different format, or on a detailed level which is not possible using existing means. In accordance with an embodiment the system allows for identifying map items within an electronic or digital map when the map is retrieved into the computer. As used herein the term “map item” or “item” is used to refer to any item displayed on a map, or any item included within a map but not currently displayed. For example, some items may only be items of information, such as the attributes of a location or a business, in which case those items are more properly thought of as map item information. Once these map items have been identified, they can be stored in the memory of a computer or other electronic device in the form of software objects. Each map item, now represented as an object, may include a number of associated parameters, typically arranged as field/value pairs. In addition, each map item may include links to one or more other map items. In the object oriented programming (OOP) world, this linking is typically provided by the use of pointers, wherein pointers are used to link related objects together. Since the map items are linked in such a manner, once a first map item is identified or selected, for example by the actions of an operator or by some other means, then pointers can be followed to other map items linked to that first map item, and so on. In this way, the operator can traverse a link of map items. In some embodiments the system provides a means by which the attributes representing the map item are displayed in a textual manner. For example, some embodiments may include a text window wherein the fields of the text window correspond to the object attributes. Grouped together the fields comprise a “record”. Each map item or item of information can be represented by an object in memory; while each object in memory includes a number of attributes.

FIG. 2 illustrates a screen display as it may be used by a user or operator to view and edit a digital map. As shown in FIG. 2, in a typical implementation, the graphical or digital map 204 is displayed in a graphical view window 202 on the operator's display screen or display 200, together with the map items that comprise the graphical view. The operator may at any time open a text window for displaying a text view of map items. In other embodiments, the text window 210 opens automatically when a map item is selected. When the operator selects a map item from the graphical view window, the text view window is updated 212 to display the record associated with that map item. As the operator selects different map items from the graphical view, the text view is automatically updated, so that at any point in time the operator can see visibly both from the graphical view window and from the text view window which object they are working with. In addition, modifications to the record in the text view window can be automatically updated 214 in the graphical view. For example, if the operator traverses through the text view window to other map items, the graphical view window changes to zoom in or to focus on the currently selected map item.

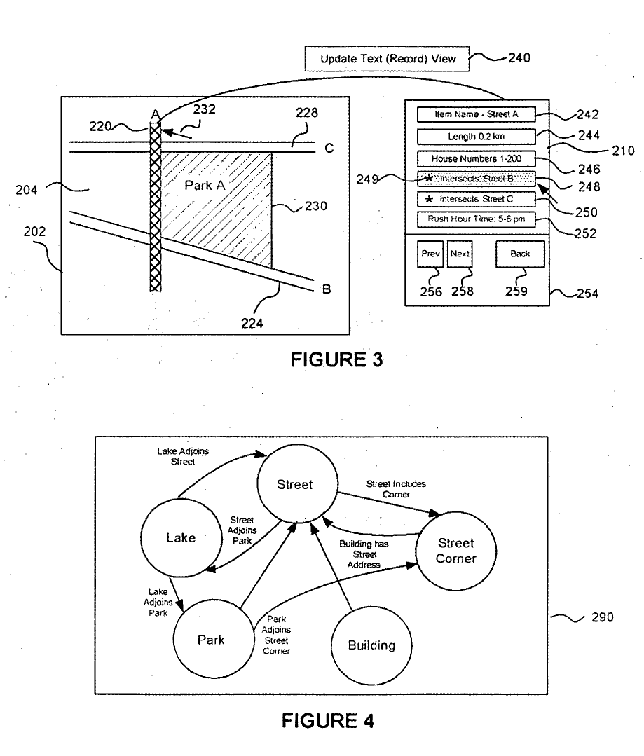

FIG. 3 illustrates how the operator can select from either the graphical view and from a variety of map items displayed therein, and display a text view which illustrates linkages between the map items and other attributes associated with each item. Conversely, the operator can select a record item from the text view and allow the graphical view to be automatically updated to focus on that view. FIG. 3 illustrates a typical digital or exemplary graphical view 202, in which a map 204 of an area is shown. A Park A 230 is bordered by a number of streets, in this example indicated as street A 220, street B 224, and street C 228. The map shown in FIG. 3 is very simple, and not entirely typical of the type of complicated maps that may typically be used; however, it is shown here for ease of illustration.

Optionally, a text view window 210 is displayed, typically in the operators screen although in some instances could be displayed on a remote screen. The text view displays a record associated with a particular map item. For each map item there is at least one corresponding record. When both the graphical view and the text view are displayed, the operator can, as an initial step, select any item that is visible within the graphical view, in this instance street A, and allow the system to display the attributes and fields (i.e., the record) associated with that map item in the text view window. Selecting a new item automatically causes the text view to change 240 to that new item. The text view window displays fields (242-252) that are associated with the map item. For example, as shown in FIG. 3, street A has a record which includes name field 242 and rush-hour field 252. Additionally, any links between this map item and any other map items are shown and indicated by a visible marker 249. These semantic links allow map items to be linked according to some underlining logical reason or format. Fields 248 and 250 of FIG. 3 are identified as semantic links indicating that they link to other map items, in this case street B and street C respectively. Typically the logic or format of linking is defined by the person responsible for the map format. For example, the format and thus the linking may depend on whether the map format is in GDF or PSI format, or in some other proprietary or non-proprietary format. Because the original map format developer defines what they perceive to be important links or associations within that map format, the system can make use of the underlying map format to determine which links it should display within the text view, rather than imposing its own sense of hierarchy or format.

This ensures that embodiments of the invention can be used with all map formats including current formats and those yet to be developed. For example, in the example shown in FIG. 3, in the graphical view the selected street A intersects both streets B and C, and Park A, which in turn means the record attributes associated with this street also include links to streets A and B. Other links may include that the intersection is associated with park A, for example, forming a corner point of the park (although these links are not shown here). This linking is created because the map format includes information about the streets and its intersection with other streets, and not because the user has guessed in any manner.

One example of map item information that can be displayed includes information that relates a street to special street closing times. For example, during rush hour some streets may be designated as one-way streets. This information is typically difficult to show on a map, and as such is similarly difficult to update or debug. In accordance with an embodiment, the special street closing information can be associated with the visible street map item. When an operator selects the street map item the appropriate map item information record is displayed in the text view, as will the information that pertains to street closing. Often this information will be represented not as discrete fields but as links to a street closing information record. Selecting that item from the text view allows the operator to traverse to the relevant information, and to view, update, or debug it.

### Digital Map Semantic Network

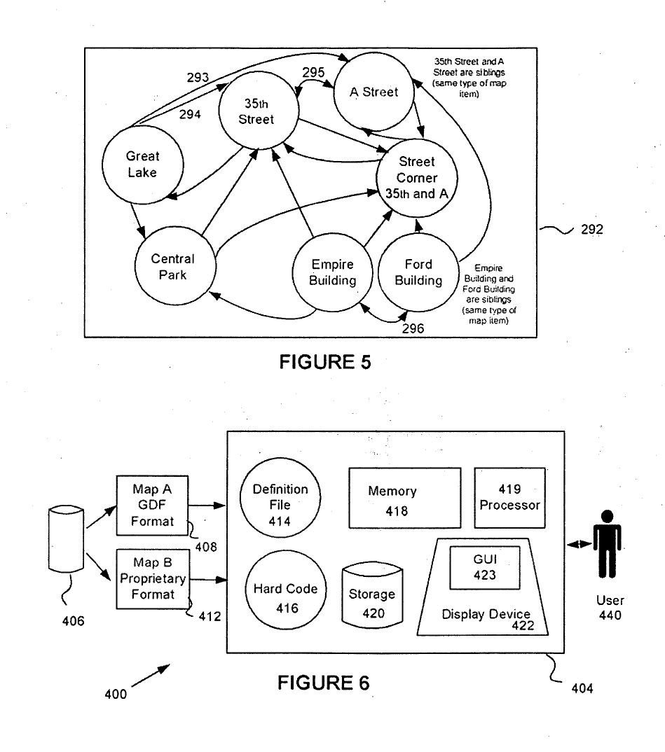

FIG. 4 and FIG. 5 illustrate how a semantic network is used to provide a basis for map understanding in accordance with an embodiment. As shown in FIG. 4, the semantic network 290 provides an understanding of the variety of underlying map item types. For example, the semantic network allows the system to understand that a lake item type may adjoin a street item type, or a park item type; or that a street item type may include a street corner item (i.e. a junction) type, and that a building item type typically has a street address and may also be located on a corner.

Embodiments of the system can make use of this understanding to create relationships between actual map items, as shown by way of example in FIG. 5. When an actual set of data is retrieved into memory, the system uses its semantic understanding of the relationships between map item types to create relationships or links between the various map data elements. Relationships can be created linking map items of different type (for example linking a street item to a lake item). In the example shown in FIG. 5, the streets named 35^{th} Street and A Street are linked to Great Lake by relationships 293 and 294 respectively. These inter-type links are used to link certain map items referred to herein as “cousins”, can be later used to allow an operator to traverse between map items of different type, either from the text view window or from the graphical view window.

Relationships can also be created linking map items of the same type (for example linking one street item to another street item, or one building item to another building item). In the example shown in FIG. 5, the streets 35^{th} Street and A Street are linked to one another by a relationship 295, while the Empire Building and the Ford Building (both of which are buildings) are linked to one another by a relationship 296. These intra-type links are used to link certain map items referred to herein as “siblings”, can be later used to allow an operator to traverse between map items of the same type, again either from the text view window or from the graphical view window.

### System Implementation

FIG. 6 illustrates a schematic of one type of system in accordance with an embodiment, in which the system allows for a variety of map formats to be retrieved, manipulated, viewed, and edited by an operator or user according to the above description. As shown in FIG. 6, the system 404 typically includes a memory 418, a processor 419, and a storage or repository 420 of some sort. The system further includes a display device 422 or monitor, including a graphical user interface or GUI 423 operating thereon by which the system can display digital maps and other information.

When a digital map is retrieved from external storage 406 (which in some instances may be the same medium as storage 420), the system may interpret it in a number of ways. When the map format is known, for example the map is in a GDF format 408 or some other ISO standard format, then the system may use a format semantic definition file 414 incorporated within the logic of the system, which is used to interpret the map format. For example, the semantic definition file can be used by the system to interpret the hierarchy of objects within the map, and relationships between those objects. In other instances, for example when the map format is a proprietary format 412, additional semantic definition files, or hard coding 416 can be used within the logic of the system to interpret the underlining map format and convert it to a semantic linkage of objects in memory, which are then interpreted by the system and used to provide features such as the parallel traversal mechanism and the actual map display. As mentioned above, an important feature of the system is its ability to work with a variety of present and future map formats. Because the system may manipulate different semantic definition files, it can be customized to work with many formats simultaneously.

### Data Abstraction Layer for Support of Map Format Inputs

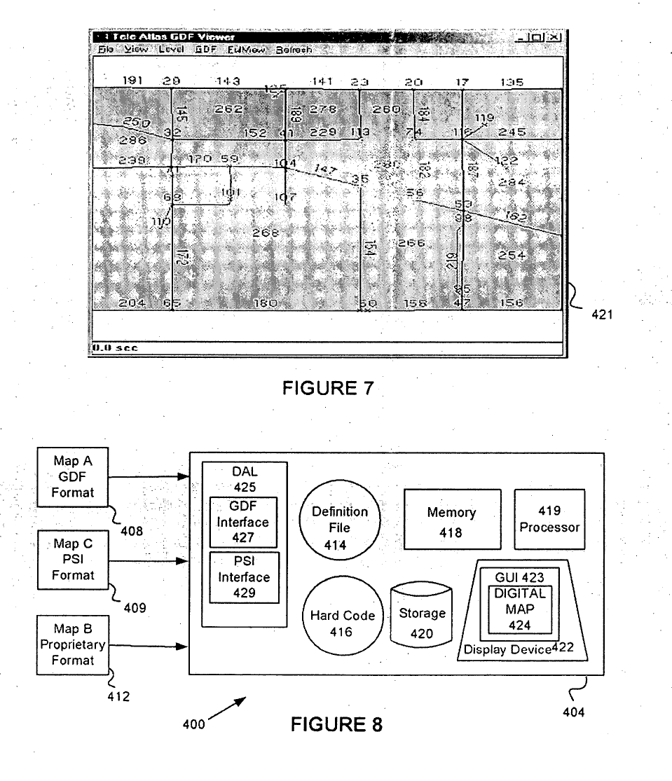

FIG. 7 shows a screenshot 421 of an embodiment which can be integrated or used within a viewer or other application to allow access, viewing, editing, or conversion of digital maps. The map viewing feature can also be integrated into, or used with, new or existing map viewer/editor applications. It will be evident to one skilled in the art that embodiments can be used with other viewer applications and with other map formats than those illustrated below, and that the invention is not limited to the particular implementation shown and described hereunder. Particularly, while the Geographic Data File (GDF) map format (an industry standard map format) and the PSI formats are used herein to describe features of the invention, other map formats may be used. Embodiments of the system are flexible enough that it can be used with most map formats currently available today, and also with those yet to be developed.

In accordance with an embodiment, the system includes a data abstraction layer (DAL) and/or a plurality of different data abstraction interfaces. The data abstraction layer can be used to allow different map formats (e.g. GDF, PSI) to be parsed and viewed. This allows the system to receive data in any of a variety of different input map formats. The map can then be displayed on a display screen to create a viewable map in a universal display format that is completely independent of the original format.

FIG. 8 illustrates a schematic of an embodiment, in which the system is designed to be extensible and to provide support for additional map formats. As shown in FIG. 8, the system 404 typically again includes a memory 418, processor 419, storage 420 of some sort, display device 422, and a graphical user interface 423. Optionally, a grid definition file 414 can be included to provide a layering or grid functionality, which is described in further detail below.

To accommodate multiple input map formats 408, 409, 412, a data abstraction layer 425, together with data abstraction interfaces, can be provided to abstract the map format from the semantic definition. Additional data abstraction interfaces can be plugged into the data abstraction layer to provide access to different input map formats. For example, in accordance with one embodiment the system can comprise a data abstraction interface for the GDF map format 427, and/or another data abstraction interface for the PSI map format 429. This allows support for new map formats to be easily added, simply by adding a new data abstraction interface to the DAL. In those instances when the map format is a proprietary format, then additional semantic definition files or hard coding can also be provided within the logic of the system to interpret the underlying map format.

In accordance with an embodiment, when the map format is retrieved the data abstraction interface for that input map format, together with the semantic definition file, is used to convert map items into a semantic linking of items that can be understood by the system. The map is then displayed on the user interfaces as a digital map 424. The map can optionally be displayed in universal screen coordinates, which allows for additional functionality and features, also described in further detail below.

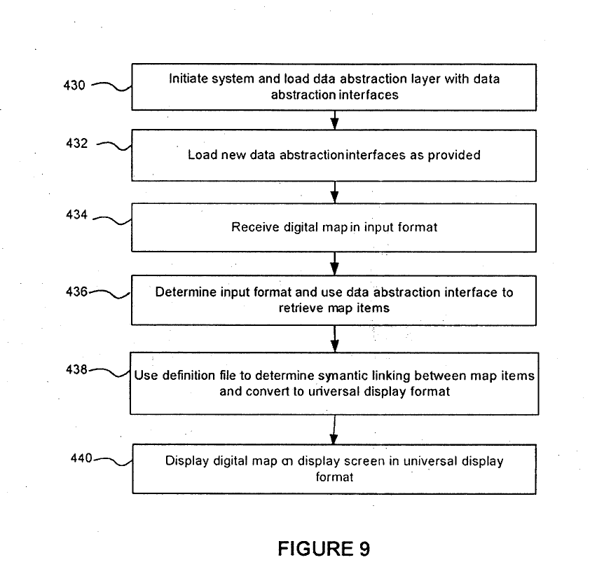

FIG. 9 is a flowchart of a method for providing support for additional map formats. As shown in FIG. 9, in step 430, the system is initiated, and the data abstraction layer is loaded, together with any data abstraction interfaces. In step 432, additional data abstraction interfaces can be added or “plugged in” as necessary to support additional map formats. In step 434, the digital map, or map information, is received in an input format. In step 436, the system recognizes the input format and users the corresponding data abstraction interface to retrieve the map items. In step 438, the system uses the semantic definition file to determine any linking between the map items, and convert the map data to a universal display format. In step 440, the digital map is displayed on the display screen or user interface.

In accordance with some embodiments, the system supports the PSI digital map format. The PSI format uses levels and tiles of map information, and is particularly suited for run-time access from local media (hard drive, CD, DVD, flash ROM), including storage and access on-board a vehicle or automobile. The PSI format is also designed to be particularly suitable for incremental data updates. For example, whenever there is a change in some portion of the map data, the entire map need not be changed. Instead, only a tile (of some level or some content) need be replaced. The structure of the PSI map format is described in further detail below, but generally allows map information to be divided into “building blocks”, levels, or layers, each of which levels contains some subset of the total information of the file, for example the basic map display, routing, name information block, guidance, positioning, POI information, advanced map display (e.g. 3D imagery), and updated infrastructure. In accordance with an embodiment, the content of the PSI format is tiled into a plurality of levels, with the highest number level being the most detailed level with as much content and shape as is possible within that particular map (i.e. it is logically at the lowest level of the map hierarchy). Conversely the lowest-numbered level has less detail and is at the top of the hierarchy. Each level includes tiles of information that comprise the level, so that for example, Resolution decreases, but total area size increases, with each successively lower level in the map. In this manner, an application can use the lower level tiles for macroscopic mapping, and the higher level tiles for more detailed mapping. Furthermore, since different types of map data can be stored at the different levels, this allows for easier updating of those map levels and map data as necessary.

Additional information about the PSI map format is described in further detail below. It will be evident that the system described herein can provide support for other input map formats, in addition to the GDF and PSI formats. The use of a DAL reduces the need for customized programming necessary to support different input map formats from M to a single input layer, where M is the number of different input map formats.

Displayable Map Information as Intermediary between Map Formats

In accordance with an embodiment, the system is able to receive data into the viewer application in a first or original map format (e.g. GDF) and then provide or output that data in a second or new map format (e.g. PSI). As described above, a plurality of different data abstraction layers can be used to allow different map formats to be interpreted and/or optionally viewed in a universal display format. Depending on the particular embodiment the universal display format can include item coordinates, or higher level descriptions of geometry and topology in the map. In accordance with an embodiment, a map format legend associated with a particular format can then be used to interpret the universal display format, and output the data into that output format. A plurality of different map legends can be used to allow different map formats to be output. In this manner the system allows for easy and universal converting of map formats. The system also reduces the need for customized programming necessary to support those different formats from (M*N) logical components to M+N logical components, where M and N are the numbers of different input formats and different output formats respectively.

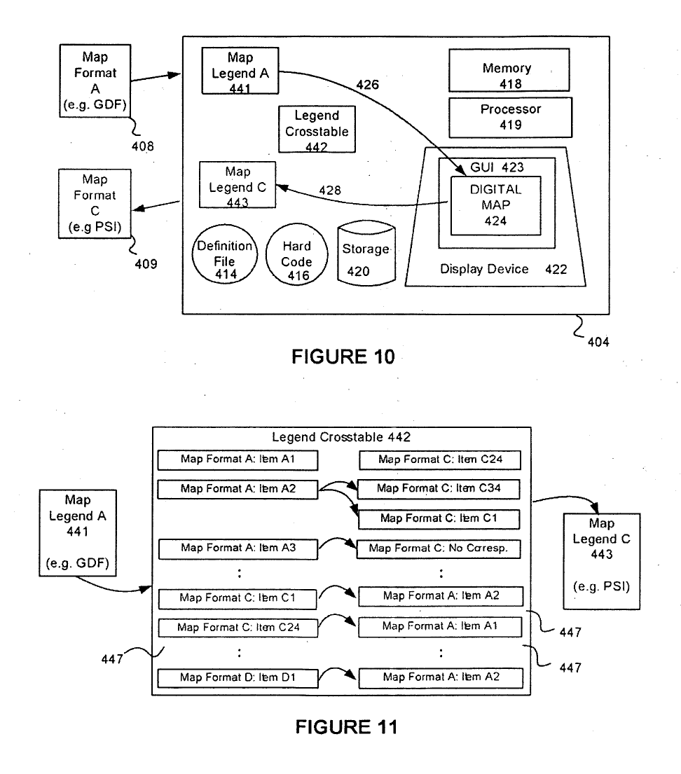

In accordance with an embodiment of the invention, the system can be used to access map formats of another type, or to convert between different map formats, for example between GDF and PSI, and other formats. FIG. 10 illustrates a schematic of a system that can be used with an embodiment of the invention, in which the system allows for a variety of map formats to be retrieved, manipulated, viewed, edited, and converted into other formats by an operator or user. As shown in FIG. 10, the system 404 again typically includes a memory, processor, and a storage or repository of some sort, together with a display device or monitor, including a graphical user interface or GUI operating thereon by which the system can display a digital map. In accordance with an embodiment, the system includes one or a plurality of map legends 441, 443 that can be used by the system to interpret the hierarchy of objects within a particular map format as it is displayed on the screen, and relationships between those objects. As shown in FIG. 10, a single semantic definition file can be used for several map formats. Alternatively, separate semantic definition files can be used for different map formats, including for example a semantic definition file for GDF, a semantic definition file for PSI, and so on.

In accordance with an embodiment, the system comprises a map legend crosstable 442 which, when combined with the map legends, allows the system to interpret a map as it is displayed 426 on the graphical user interface, and then output 428 the map data to a new map format. A single map legend can be used for several map formats. Alternatively, separate different map legends can be used for different map formats, including for example a map legend for GDF display, a map legend for PSI display, and so on. Support for additional map formats can be added to the system by adding additional map legend information to an existing legend crosstable, and/or by adding additional map legends.

In accordance with an embodiment, the system allows map data of a first map format “A” (for example a GDF format map) to be retrieved and viewed as a digital map on the display. Depending on the format to be retrieved the system can use one or more of the map legends to interpret the map objects and display them 426 on the screen. Upon demand by the operator, the system can then interpret 428 the displayed digital map objects, using the map legend, to determine appropriate information for the objects that are currently displayed in the map and, and convert or save those objects into a second or output map format “C” (for example a PSI map). A selection of the displayed objects, or the entire map, can be converted in this manner. The second or output map format can then be saved to a disk, or used in another manner as implementations may require.

FIG. 11 illustrates a map legend crosstable in accordance with an embodiment. As shown in FIG. 11, the legend crosstable is used to map item legend information from one map format legend (e.g. GDF), to another map format legend (e.g. PSI). A plurality of entries 447 in the crosstable link the displayable (in screen coordinates) map item types of a first format, with corresponding displayable (in screen coordinates) map item types of a second format. Additional map formats and map legends can be added by adding to the legend crosstable. In this manner, a map of one format can be easily converted to one or several other map formats. As shown in FIG. 11, in some instances a map item of one format may correspond to two or more map items in another format. Similarly, some map items of one format may have no corresponding map item in the other format. This information can be recorded in the legend crosstable by means of an index or pointers, together with as necessary multiple pointers, or in some instance an absent or null pointer for certain map items.

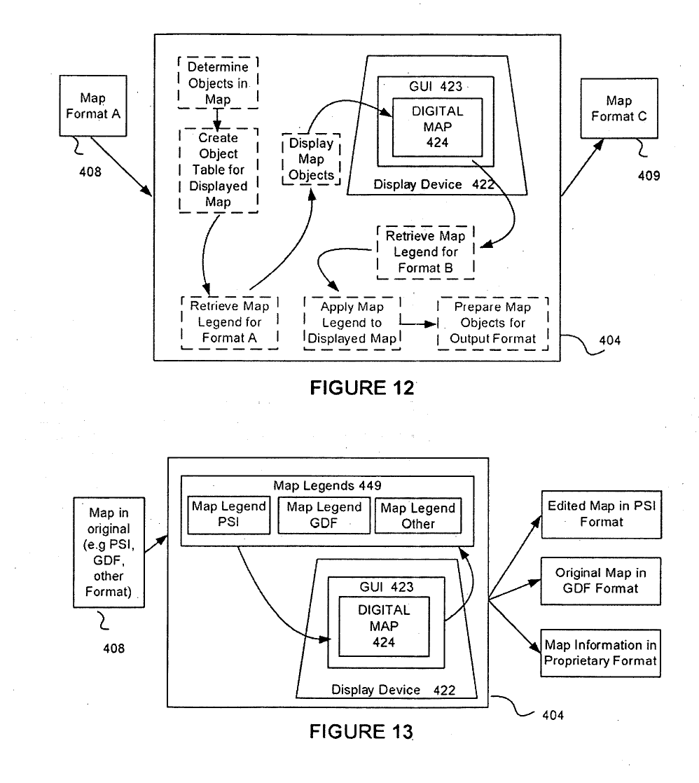

FIG. 12 illustrates a system that can be used with an embodiment of the invention, in which the system allows for a variety of map formats to be retrieved, manipulated, viewed, and edited by an operator or user according to the above description. As shown in FIG. 12, the system first receives map data in a map format “A” (for example GDF). The system uses an input map legend and semantic definition file to determine objects in the map to display. In accordance with an embodiment, if the map data is capable of being viewed at different levels or different degrees of information, then the system displays the chosen level, and maintains an object table for the displayed map objects. The system then displays the map and the map objects on the screen. The displayed map is in universal screen coordinates and, subject to the differences between the map legends, is independent of the underlying map data. To convert the displayed map into an output format the system retrieves the map legend (or if several map legends exist then the map legend that corresponds to the output format). The system applies the map legend of the output format to the displayed map, and uses it to interpret those objects that are currently displayed. The system then prepares the currently displayed map objects for output, and saves the map into the desired format “C” (for example PSI).

When the map format is of a type that displays levels of information or sequential tiling (for example the PSI format), then the map data can be retrieved and displayed at those different levels. For example, the map data content within the PSI format can be tiled into a plurality of levels. In accordance with an embodiment, the system allows such data to be retrieved and displayed at the desired level. That level of information (corresponding to the currently displayed map) can then be output to the desired format. This allows map a desired level of map information to be output, without requiring that the entire map be converted from one format to another format. Additional information about the PSI map format is described in further detail below. It will be evident that the system described herein can provide support for other input map formats, in addition to GDF and PSI.

FIG. 13 illustrates a system that can be used in accordance with an embodiment, in which the system allows for an input map format to be received, and a variety of map formats to be created, manipulated, viewed, edited and output by an operator or user according to the above description. As shown in FIG. 13, an input format, for example PSI or GDF, is received into the system. The system uses one of a plurality of map legends 449 to display the map data on the screen. The system then uses another one of the plurality of map legends to interpret portions or the entire map as displayed, and to either edit the map, convert map information, or output the map or portions thereof in another or a proprietary map format.

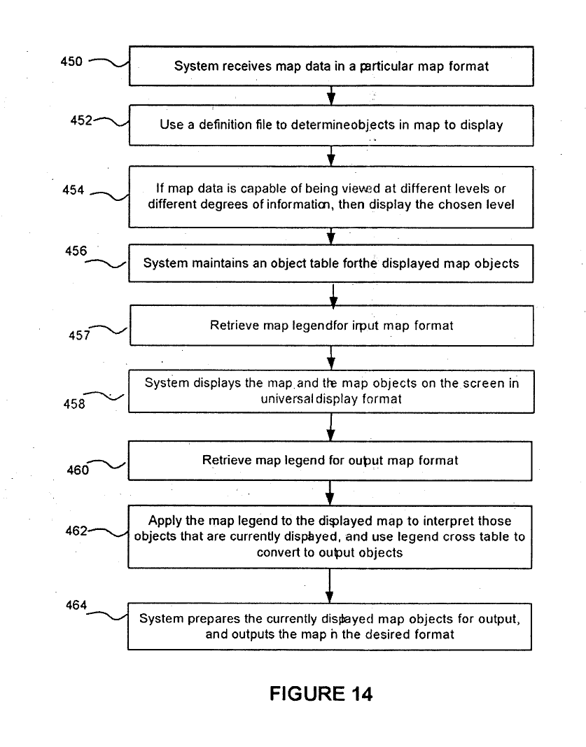

FIG. 14 illustrates a flowchart that can be used with an embodiment of the invention, in which the system allows for a variety of map formats to be retrieved, manipulated, viewed, and edited by an operator or user according to the above description. As shown in FIG. 14, in step 450 the system first receives map data in a particular map format. In step 452 the system uses a semantic definition file to determine objects in the map to display. If the map data is capable of being viewed at different levels or different degrees of information, then in step 454 the system displays the chosen level. In step 456 the system maintains an object table for the displayed map objects. In step 457 the system retrieves a map legend for the input map format. In step 458 the system then displays the map and/or a selection of the map objects on the screen. To convert the displayed map or map items into another format, in step 460, the system retrieves the map legend for the output map format. In step 462 the system applies the map legend to the displayed map and uses it, together with the legend crosstable, to interpret those objects that are currently displayed. In step 464 the system then prepares the currently displayed map objects for output, and outputs the map into the desired format.

### Viewing, Debugging and Converting Map Data

In accordance with an embodiment, the system can be used to view, edit, or debug map data, and perform conversions of map data. Techniques are also provided that assist in previewing and debugging the conversion of the map data from one map format to another format. Embodiments of the system allow for either alternately or concurrently presenting two or more digital maps in different map formats, and/or both a graphical map and textual information describing the objects or items within those maps. The system allows the user to compare the maps, and to preview conversions of maps, and to view or modify records within a map by either selecting items from a graphical map or from a text view. When the user wishes to view or modify a map, the user can display one or more digital maps on a computer screen, and display or preview another map format or a text view on the same or a different computer screen. As the user selects items within the map, for example a building, street, or park, typically by clicking on the item with a mouse or with some other form of pointing device, the map window and/or text window changes to reflect the properties of the map item currently selected. The operator can then navigate between map objects better from the graphical view or the text view. Each map object or item is associated with a particular data record that describes the properties or attributes of that item. As used herein these properties may include, for example, a street name, or some relationship of this object to another object. The relationship may be, for example, how one street intersects another street to form a street corner or intersection, or that one street abuts a particular park. The system makes use of these relationships by extracting relationship information from the map itself and displaying it to the user in the text view format so that the user can then select from this text information to easily navigate between map objects, and to make changes to the information defining or associated with those objects. Modifying a text record to update an attribute associated with an object can be used to produce an immediate change in the graphical map itself. At the same time being able to view, display, and edit the record associated with an object provides an easy mechanism by which a map editor can change object attributes. In this way the map can be viewed in a more useable manner, and can be easily and quickly updated to reflect changes in the underlying objects. When the use is satisfied with the quality of the map data, the digital map can be stored, saved, or output, to one or more output map formats, using the techniques described above.

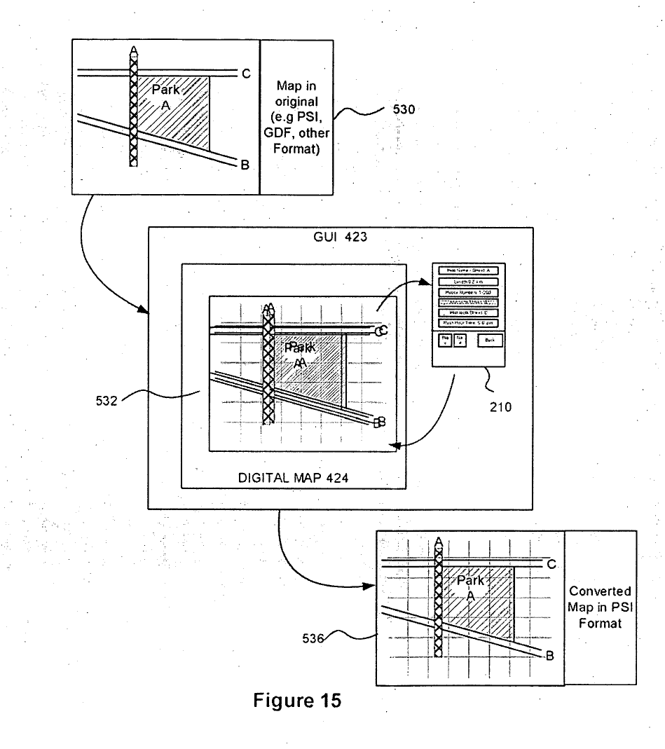

FIG. 15 illustrates an embodiment that allows a preview of an output digital map format, such as a PSI format map, to be compared to an input map format, for use in converting between map formats. This allows for a digital map to be previewed, converted, and debugged against an input map source. As shown in FIG. 15, a digital map in an original input format 530 is received into the system. The input map format can be any format, for example GDF or another map format. The input digital map 424, together with a preview of the output map data, can be displayed together or overlaid 532 on the same GUI 423 for an operator to review. This provides the operator with a preview of what the output map data or digital map will look like following conversion. For example, a GDF format map can be displayed on the same screen, or overlaid with, a PSI format map of the same map area. In the case of PSI output a PSI grid can be overlaid on the original map data to reflect the grid-like layout of the PSI format, and to show the operator what the eventual output PSI map would look like. The additional map format data can be retrieved, or generated from the original source using the techniques described above. Overlaying the two sets of data, or displaying the two sets in close proximity allows the operator to quickly review differences between the maps. The operator can also retrieve a text record 210 for any map item, to make changes directly into the data record for that item. If the operator wishes, they can output the converted digital map data in a target map format, for example PSI. In accordance with an embodiment, the operator can also edit the converted digital map data as necessary.

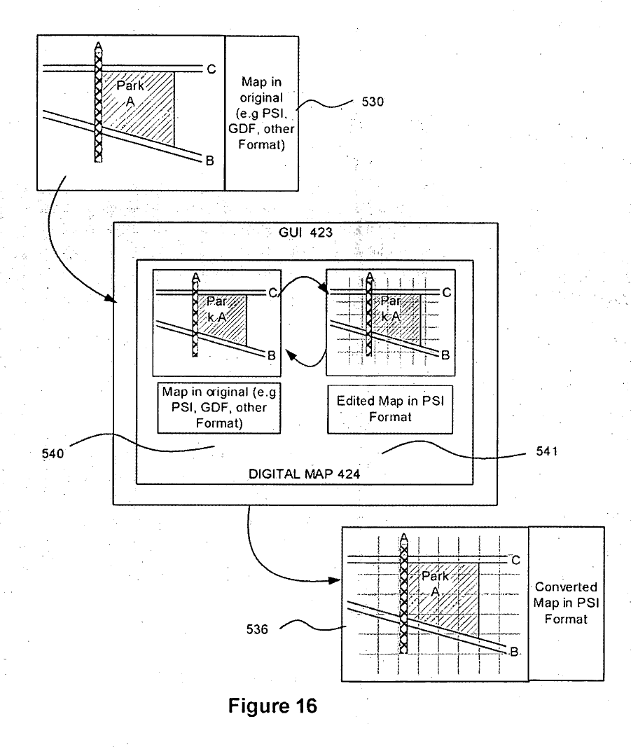

FIG. 16 illustrates another embodiment that allows for a preview of an output digital map format to be compared to an input map format, for use in converting between map formats. This allows for a digital map such as a PSI format map to be previewed, converted, and debugged against an input map source. As shown in FIG. 16, the original version 540 of the digital map 424, together with a preview of the output map data 541, can be displayed together or side by side on the same GUI 423 for an operator to review. This provides the operator with a preview of what the output map data or digital map will look like following conversion. For example, a GDF format map can be displayed on the same screen side by side with a PSI format map of the same map area. In the case of PSI output a PSI grid can be overlaid on the preview to reflect the grid-like layout of the PSI format, and to show the operator what the eventual output PSI map would look like. As described above, the additional map format data can be retrieved, or generated from the original source, and the operator can also retrieve a text record for any map item to make changes directly into the data record or can output the converted digital map data in a target map format, for example PSI. Again, in accordance with an embodiment, the operator can also edit the converted digital map data as necessary.

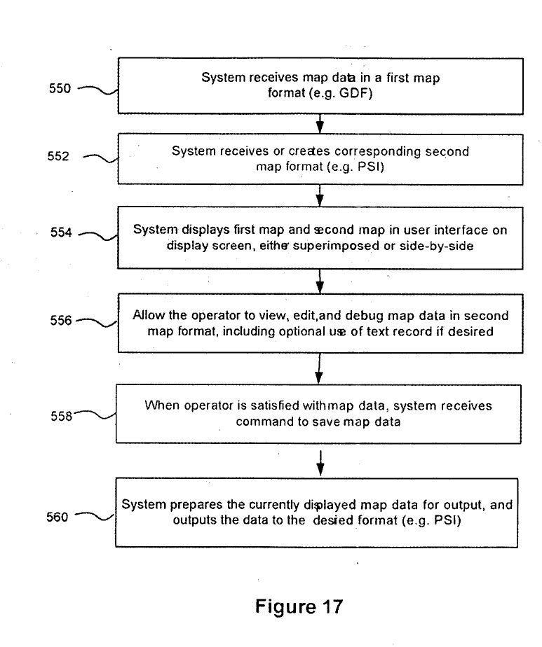

FIG. 17 illustrates a flowchart that can be used with an embodiment, in which the system allows for an output digital map format, such as a PSI format map, to be compared to an input map format, for use in converting between map formats. This allows for a digital map such as a PSI format map to be previewed, converted, and debugged against an input map. As shown in FIG. 17, in step 550, the system receives map data in a first map format (e.g. GDF). In step 552, the system receives, creates, or converts the map data into a corresponding second map format (e.g. PSI). In step 554, the system displays the first map and second map in user interface on display screen, either superimposed or side-by-side. In step 556, the system allows the operator to view, edit, and debug map data in the second map format, including optional use of text record if desired. In step 558, when the operator is satisfied with map data, the system receives a command from the operator to save the map data. In step 560, the system prepares the currently displayed map data for output, and outputs the data to the desired format (e.g. PSI).

In accordance with an embodiment, the system also allows for debugging that includes an analysis of the target format in terms of data specification, rather than data content. In accordance with this embodiment, the operator can determine the extent to which the target or output map format is able to reflect the data content of the source or input map format. This may include aspects such as the flexibility of the attributes within the data (for example, whether a particular type of attribute can be represented in the output, and whether the representation handles unusual cases), and the efficiency of the data representation (for example, the size and the complexity of the data output representation). For example, an input map or source data may support area features with multiple faces in its map format; however, a particular choice of output map format might only support a single face per area, thus forcing multiple area features to capture the same content. An embodiment of the system can be used to visualize and detect such potential problems.

By way of example, different map formats handle area features differently. Normally, an area feature may consist of many faces. This is common in the GDF format when in feature mode: the various faces of the area are the regions enclosed by the road network that surround and sometimes bisect or intersect the area. In the PSI format there are three different methods of encoding an area. The RELATIVE and DIFF encoding methods support the notion of multiple faces in which the list of coordinates includes flags to mark the end of a face. However, if the attribute CoordCompression is set to COMPRESSION_NONE, then the RELATIVE and DIFF encodings are not allowed, and an area can instead have only one face. So if the original input GDF area has multiple faces and the operator selects an output option that cannot support those multiple faces, then the system must either (a) ignore the area, (b) signal an error condition, or (c) generate an area feature in the output for each face of the input area feature.

For example, if one considers an input map that includes a rectangular shaped park (which is a commonly used area feature), the other lines on this map might be the roads, rivers, and other items that break up the park into other smaller elemental areas. In some data models, for example in GDF, the park area feature can be described as a composite area that is in turn comprised of smaller areas or faces. In PSI, under some circumstances it is considered “format illegal” to create a feature with multiple faces. Thus, in order to show the park using the PSI format it must be shown by creating separate park features for each of the elemental areas and by then designating those components as part of the overall park. This is redundant, and also makes the process of map conversion more difficult since it has the potential to introduce unwanted effects. In accordance with an embodiment the viewer allows for viewing these effects or “discovering” unwanted effects by seeing how the rules of translation actually behave. As described above, this can be done by visualizing the data in, for example, GDF, and by then visualizing the same data in PSI in the viewer, with both its graphical and its textual outputs. Using either the overlay approach or the side-by-side approach described above with respect of FIGS. 16 and 17 allows the operator to quickly discern the differences between map features as presented or stored in the different source and target map formats, and to then edit or debug them accordingly.

Embodiments of the system can also be useful in debugging the translation process itself. For example, if the output has missing or wrong attributes or geometry, then the issue may be the translation itself, rather than the data content of the source, or any restrictions imposed by the output map format.

### Map Level and Tile Features

In accordance with an embodiment, techniques are provided that assist in reading, storing, and outputting data to various formats, and in particular to formats such as PSI that can include multiple levels of tiled map information. Using the techniques described above, a digital map can be displayed on a display screen in a universal display format that is independent of the original format. The digital map as displayed can then be parsed using a map legend, and techniques can be used to output different map data based on the currently viewed map display. If a user modifies the map display to display a greater (or lesser) detail of resolution, then the set of map data that is output can also be varied accordingly.

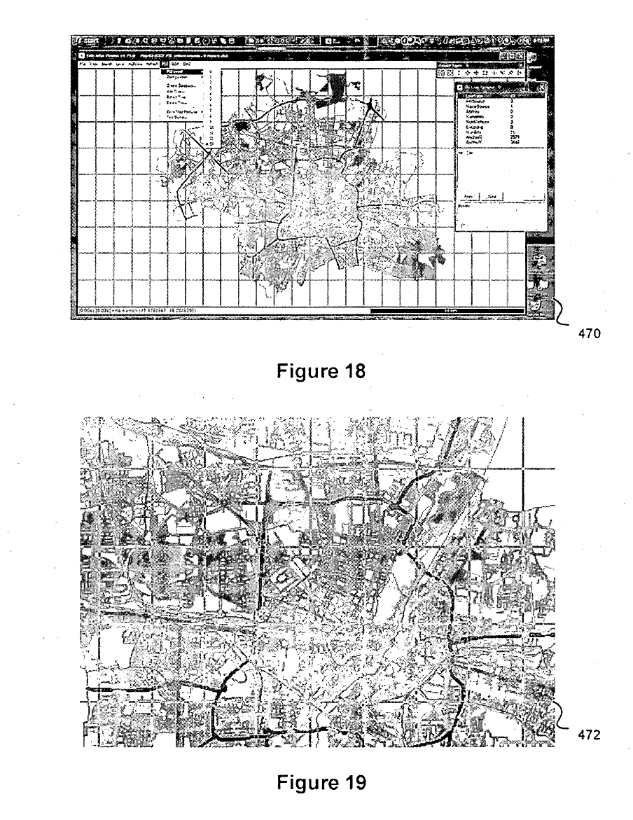

In accordance with an embodiment the system optionally includes features for handling those map formats that include levels of information or sequential tiling (for example the PSI format). FIG. 18 shows a screenshot 470 of an embodiment that can be integrated or used with a viewer application to allow viewing and editing of digital maps. FIG. 19 shows another, close-up view 472 of the same map. As shown in FIGS. 18 and 19 the displayed map is a PSI format map.

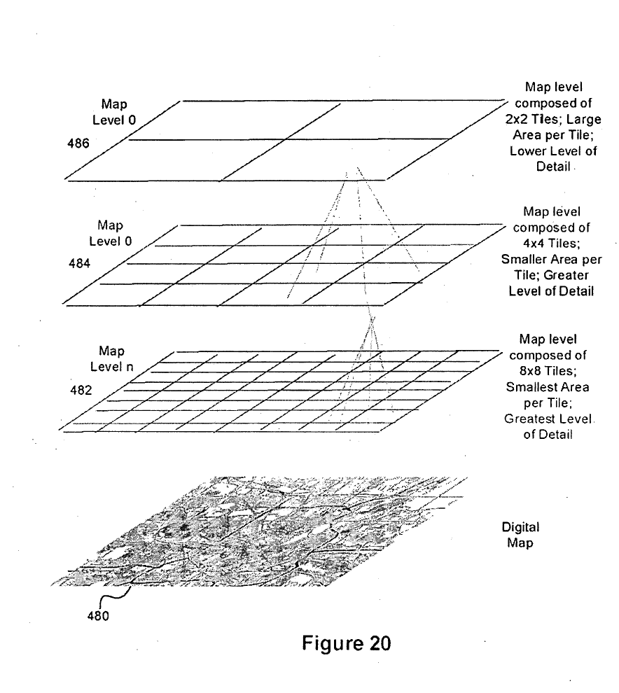

As described above, the PSI format is divided into “building blocks”, levels, or layers, each of which levels contains some subset of the total information of the file: e.g., the basic map display, routing, name information block, guidance, positioning, POI information, advanced map display (e.g. 3D imagery), and updated infrastructure. FIG. 20 illustrates multiple levels and tiles of information as stored in a multi-level map format such as PSI. As shown in FIG. 20, the underlying digital map 480 can be represented as a plurality of levels 482, 484, 486. In the example of the PSI format the highest-numbered level 13 is the most detailed level, with as much content and shape as is possible within that particular map, i.e. it is logically at the lowest level of the map hierarchy. Conversely the lowest-numbered level 0 is at the top of the map hierarchy. Each level includes tiles of information that comprise that level, so that for example each level 13 tile is about 2 kilometers by 2 kilometers in area; whereas a level 12 tile loses some resolutions and is about 5 by 5 kilometers in tile area. It will be evident that PSI is described here by means of example, and that other multi-level map formats, having different arrangements of levels and tiles could be used).

In accordance with an embodiment, selecting a particular level from the pull-down menu displays the tiles corresponding to that level. When the map is “zoomed out” to a large extent, then the system automatically hides the boundaries between the tiles.

In accordance with an embodiment, the boundaries between the tiles are not only used for display purposes. As described above, the system can also allow for an input map format to be received, and a variety of map formats to be created, manipulated, viewed, edited and output by an operator or user according to the above description, including where desired portions or the entire map as displayed. The system can also output the displayed map or portions thereof in another or a proprietary map format. In accordance with an embodiment this technique is further used to interpret information from any map displayed on the screen (from any source and any original map format), and convert the information to corresponding PSI tiles (which can also be automatically clipped on tile boundaries, even across resolution differentials). When the number of tiles is too large to output to a single file (for example if the map covers an entire country), then the tiles can be collected automatically into an SQL database.

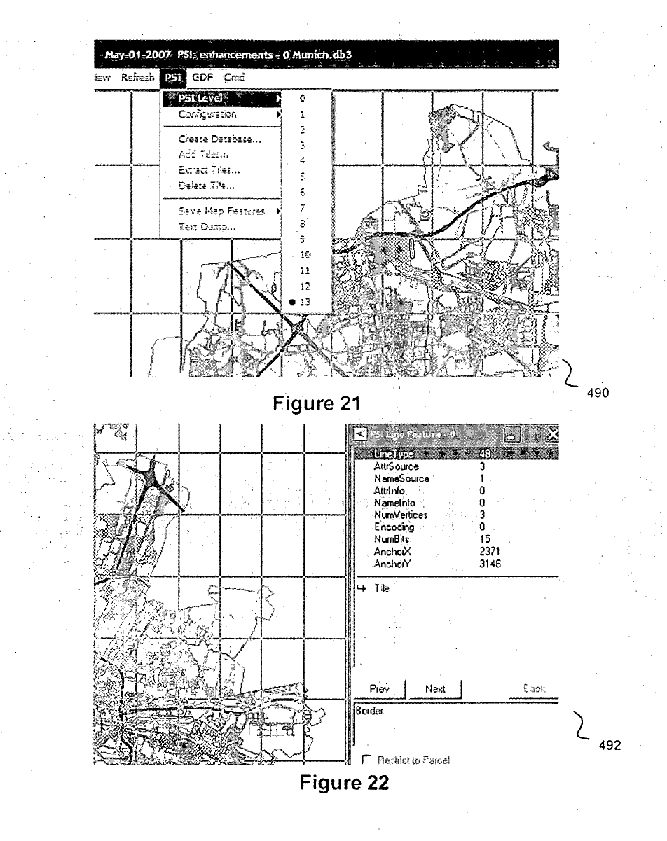

FIG. 21 shows another screenshot 490 of an embodiment that can be integrated or used with a viewer application to allow viewing and editing of digital maps. A pull-down menu can be used to display selected PSI levels. If the operator desires then the system can be used to save map features to a particular PSI level. Since different map formats may use different resolutions to store and display maps, the system must take this into account when saving data to a different format. For example, in the GDF format the resolution is at most 7 decimal points for lat, long pairs in degrees. In the PSI format the resolution can be more precise (in the area of sub-centimeter accuracy). In accordance with an embodiment, when the system converts map data from GDF to PSI, the system deliberately leaves “tails” on each feature. A PSI conversion routine can then cut the tail to a proper size during output of the data.

FIG. 22 shows another screenshot 492 of an embodiment that can be integrated or used with a viewer application to allow viewing and editing of digital maps. As shown in FIG. 22, attributes for individual map objects can be edited before outputting them (to PSI or another format). This ensures that when saved, the data more accurately matches the operator's requirements.

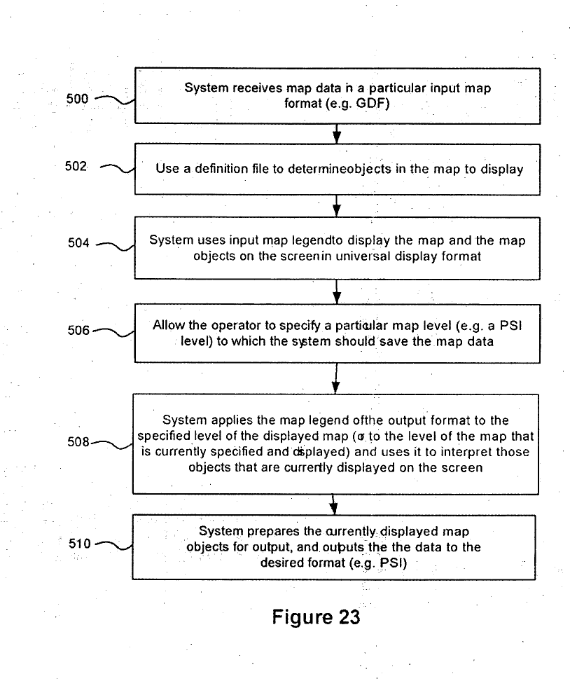

FIG. 23 illustrates a flowchart that can be used with an embodiment to allow for conversion of map data to PSI format. As shown in FIG. 23, in step 500 the system first receives map data in a particular input map format (e.g. GDF). In step 502 the system uses a semantic definition file to determine objects in the map to display. In step 504 the system then uses the map legend for the input map format to display the map and the map objects on the screen. In step 506 the system allows the operator to specify a particular PSI level to which the system should save the map data. In step 508 the system applies the map legend of the output format to the specified level of the displayed map (or to the level of the map that is currently specified and displayed) and uses it to interpret those objects that are currently displayed on the screen. In this manner the operator can either display a particular map level, and then export or output that level. Alternatively the operator can display a different map level, and uses a drop down menu or other device to choose a map level for output. In step 508 the system prepares the currently displayed map objects for output, and outputs the data to the desired format (e.g. PSI).

Map Data Access using a Bit Stream Processor

In accordance with an embodiment, the system also includes features to allow efficient access and storage of map data. This is of particular use with some data formats, including PSI, which are designed to reduce overall data storage space in return for slightly longer access (reading and writing) times. In some map data formats each map item is not necessarily stored or encoded using a consistent byte-aligned number of bit length. For example the number of bits in a variable may not be byte-aligned such as 16, 32 or 64 bits, but could instead be 7 bits, 13 bits, or some other length. Instead, to save overall storage requirements, the map items can be stored as different byte length variables. This necessitates additional processing during reading and writing the data. In accordance with an embodiment a bit stream processor provides a reader and/or a writer functionality, which allows the system to read and/or write an arbitrary number of bits at any bit position in the data stream. In accordance with some embodiments the order of access can also be random.

Typical access to any data stream is byte oriented, so that reading or writing data normally requires the application to consider the nearby bits in the same byte being considered. For reading, this means that unwanted bits must be excluded and the remainder must be shifted to their proper position in the final result. If the desired bits also span byte boundaries then there are additional complications in piecing together bits from multiple bytes to assemble the desired result. For writing, it is even more complicated, since the unreferenced bits in a byte must be preserved. This means bytes must be read, partially altered and written again. An additional issue is maintaining correct byte order when reading and writing values in environments in which the underlying machine byte order is different, such as big-endian and little-endian architectures, so that the same bit stream will work in all environments.

In accordance with an embodiment, the bit stream processor, including a bit reader and/or writer addresses these problems by viewing the data stream as bit stream instead of a byte stream. As such there is the notion of a bit position in the stream. In accordance with an embodiment, access to the stream occurs at the current bit position. After reading or writing a number of bits at the current bit position, the current position is changed to the position after the last bit that was read or written. Numeric values that are retrieved from or written to such a data stream are viewed independently of their physical context in the bit stream. In particular there is no need to be concerned about ignoring or preserving neighboring bits in physical bytes. This is handled automatically by the reader/writer as needed. Furthermore, the bit position can be set to any desired position in the bit stream, so that random access is easy. Finally reading and writing can be mixed in any desired combination. This supports easy creation of data in which some parts of the stream content are not yet known, only its size and position. This might occur for example if a count of the number of items needs to be recorded, but the number will depend on processing that has not yet been done. The writer can then skip over this part of the data, write other data content, and then later return to this position in the stream and complete or update it.

To consider an example, in order to read a value A consisting of n bits from the current bit position of a bit stream, the reader must first determine which physical bytes of the data are involved. Assume for notation that the bytes are B1, . . . , Bm in this order. The bit stream is maintained in big-endian byte order, regardless of the byte order of the machine on which the reader is running. This means that A is broken up into blocks of bits, A1, . . . , Am. A1 contains the highest order bits of A that are in byte B1, while A2 contains the next block of bits of A that are in byte B2, and so on, until finally Am contains the lowest order bits of A that are in byte Bm. Generally, A1 and Am will be partial bytes where A1 contains the low order bits of B1 starting at the current bit position, and Am contains the high order bits of Bm, while all other Ai will contain the full byte contents of the corresponding byte Bi. In accordance with an embodiment, the reader shifts the bits of each byte Bi, with appropriate masking of B1 and Bm, and assembles the bytes into a final numeric value A.

In accordance with an embodiment, the writer can engage in a similar process, except that the masked bits in B1 and Bm will be added to the blocks A1 and Am to form a complete byte, and then the bytes A1 through Am will replace B1 through Bm in the bit stream.

In accordance with an embodiment, the bit reader and writer treat the data stream as a buffer in memory. This is convenient, since it allows any memory buffer to be managed by a bit stream reader or writer with virtually no overhead. Only the location and size of the buffer needs to be specified to initialize the reader or writer. This is also useful in a conventional database environment where binary content is recorded as blob. Once the blob is retrieved it can be immediately attached to a reader and treated as a bit stream source. Conversely, when a buffer is created with a bit stream writer it can then be stored in a physical storage medium, such as a database or some other file system.

In accordance with an embodiment, the bit stream reader and writer includes the ability to resize the buffer as needed, without disturbing the reader/writer state. The current bit position can be retrieved and modified at any time. Reading and writing on a bit stream can be mixed in any order.

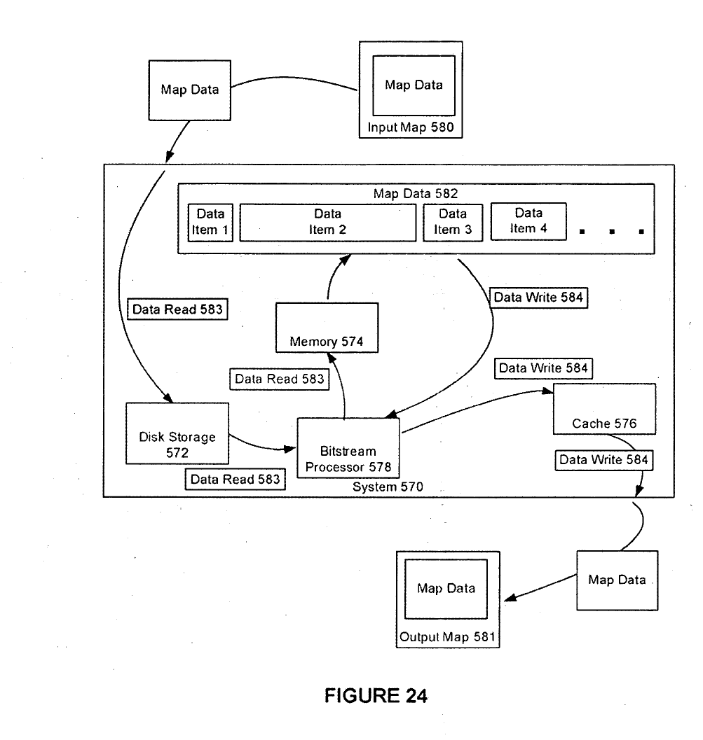

FIG. 24 illustrates a schematic of an embodiment that allows for map data to be read, edited, and stored into the system. As shown in FIG. 24, the system 570 comprises a disk storage 572, memory 574, cache 576, and a bit stream processor 578. The bit stream processor provides a staging area for efficient reading and writing of map data, and also provides security for adjoining data portions that use different byte length variables. An input map 580 including map data can be read into the system, and optionally written to an output map 581. Input and output map formats include PSI and other map formats. As map data is read 583 into the system, instead of reading it directly from disk storage to the display screen, which takes time, the bit stream processor places the map data in memory and reads it from there. As map data is written 584 to the system for storage or output, which again takes time, the bit stream processor caches the map data in the cache, and writes it from there.

In accordance with an embodiment, the bit stream processor can be used to read and write PSI format map data. The PSI format requires a stream of data items or various sizes (from 1 to 32 bits) that are packed with no unused space or data alignment assumptions. This means that at a low level all data must be converted to or from a bit stream. In accordance with an embodiment, the map viewer application can include a PSI component which implements a bit stream reader and writer. This is used as the final step on output to generate PSI data, and the first step on input to interpret and represent PSI data. In the context of PSI, the bit stream reader and writer allow the writing/reading of N bits of data to/from the memory buffer at any given bit position, without disturbing neighboring bits. Since data must be accessed in units of a byte (a minimum of 8 bits), the reader and writer must concern themselves with joining fractions of bytes of data, so that the process is invisible to the calling software.

In practical terms the bit stream is also a means of compressing the data. Navigation systems that use digital maps typically have memory constraints (often moreso than processor constraints). As such a goal is often to balance memory and processor speed. Formats such as the PSI format use tiles, wherein the system may not know the number of points/lines/areas generated until it is completed (a minimalist approach). After completion it must then go back and update the tile contents at particular positions to update these numbers. If the system performs a full unpacking of a tile, then it must place all of the content into unique variables which can be accessed directly and quickly. However, this approach requires the system to accept the cost of the fully unpacked data size within memory. If large tiles or many tiles are used then this approach might not be feasible. Alternatively, the system can choose to not unpack or store anything, except the information that is required to answer the current query. While this approach is minimal in terms of space usage, it requires redigesting the tile bit stream every time the system must process a query that involves something in that tile. While this approach is smaller, it may also be slower. In accordance with an embodiment, the system digests the data as it is read, and stores the bit locations of various “memory markers” in the bit stream. Such markers can include, for example, the start of an “Area Feature List” or the Start of a “Line Feature List”. In PSI, the format allows the system to provide information about area features if it is known where the area feature list starts. As such, in accordance with an embodiment the system does not then need to start digesting the bit stream from the beginning to again determine where the area features start. This approach produces a much faster processing time for queries, at the cost of only a modest amount of memory. In accordance with an embodiment the system stores not just the beginning of the areas, but also the start of each area feature, in a list in 1-1 correspondence with the area features. Then each feature is a direct lookup into the tile data.

Digital Map Viewer with Magnifying Tile Feature

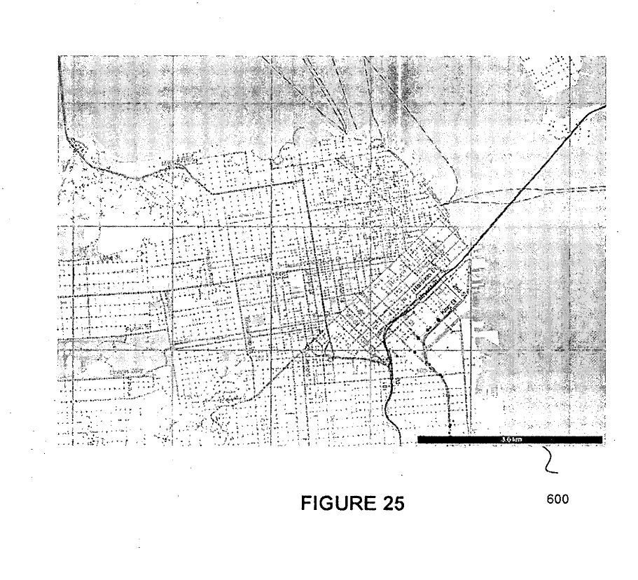

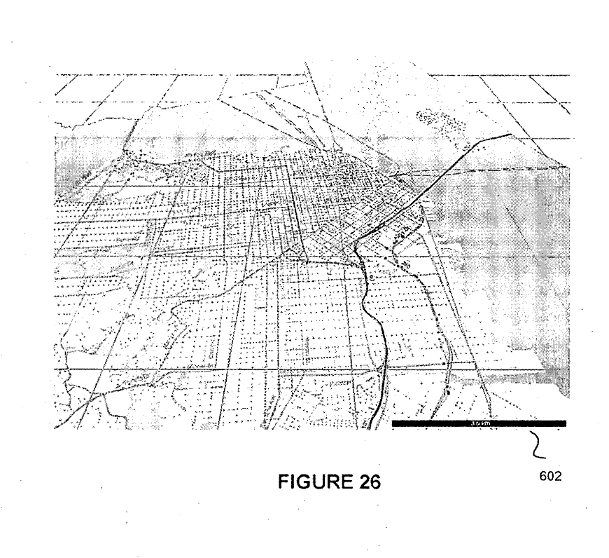

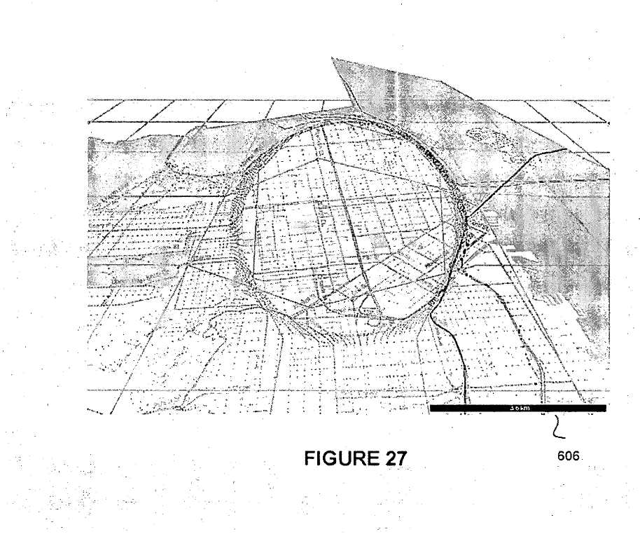

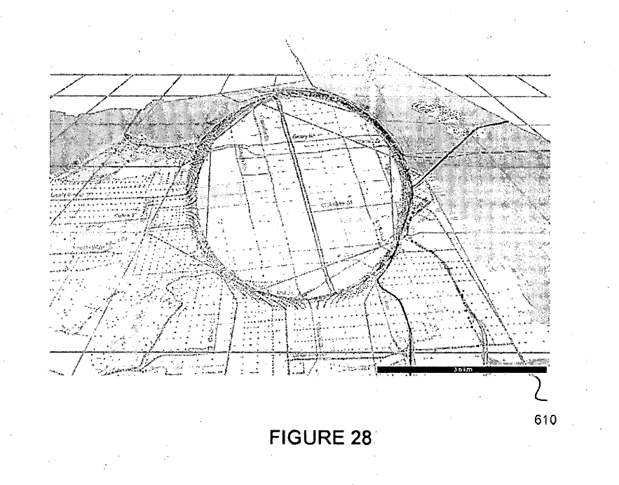

Some or all of the above features can be included in map viewers and other applications that include various embodiments of the invention. FIGS. 25-28 illustrate screenshots of a viewer for displaying previewing, and accessing levels of a multi-level digital map data. As shown in FIG. 25, an input map 600 can be read into the viewer application. As shown in FIG. 26, the map can be tilted 602 or displayed in three dimensional view. As shown in FIG. 27, a magnifying glass 606 can be used to focus on a section of the map, or a level of map data. This can be used with the debugging features as described above to compare and debug map data. Similarly the magnifying glass can be used to view levels of map information, such as in a PSI or other multi-level format digital map, and then edit or output that level of the map. As shown in FIG. 28, the operator can easily change the focus area 610 of the magnifying glass, to view a different portion of the map, or a different level of a multi-level map. Using this approach, different levels of map data can be accessed, viewed, edited, and stored as output.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above. Included in the programming (software) of the general/specialized computer or microprocessor are software modules for implementing the teachings of the present invention.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, it will be evident that the above described viewer and editor features can be incorporated into other types of software application beyond those described, and that a wide variety of map formats may be viewed and manipulated with the invention, in addition to the GDF and PSI formats described herein. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for providing efficient access to digital map data, comprising:
a computer having a fixed disk or other non-volatile storage device for storage and archival of data;
a memory or other software accessible medium for enabling retrieval and access to the data;
a cache for temporarily caching some of the data;
a set of map data stored on the computer storage device, that corresponds to a digital map and that has a plurality of map items defined therein, wherein the digital map has a first map data format in which each map item is not necessarily stored or encoded using a consistent byte length; and
a bit stream processor that performs the steps of,
while map data is being read by the system from the storage device to the memory, instead of reading it directly from disk storage to a display screen, places the map data in the memory and reads it from there, and
while the map data is subsequently by from the system to the storage device or another output, caches the map data in the cache and then writes it from the cache.

2. The system of claim 1 wherein to save overall storage requirements, the map items are stored as different byte length variables on the storage device.

3. The system of claim 1 wherein the bit stream processor provides a staging area for efficient reading and writing of map data, and also provides security for adjoining data portions that use different byte length variables.

4. The system of claim 1 wherein the bit stream processor allows an input map to be read into the system in the first map data format, and written to the output as a second or different map data format.

5. The system of claim 1 wherein the first map format is Public Sector Information (PSI) format.

6. The system of claim 5 wherein the Public Sector Information (PSI) format uses a stream of data items of various sizes from N=1 to N=32 bits and wherein the bit stream processor allows the reading and writing of N bits of data from and/or to the memory at any given bit position, without disturbing neighboring bits.

7. The system of claim 1 wherein the map data is stored on the storage device in a compressed format.

8. The system of claim 7 wherein digests the map data as it is read from the storage device, and stores the bit locations of various “memory markers” in the bit stream so that the system does not then need to start digesting the bit stream from the beginning to again determine where the area features start.

9. A method for providing efficient access to digital map data, comprising the steps of:
providing a computer having a fixed disk or other non-volatile storage device for storage and archival of data;
providing a memory or other software accessible medium for enabling retrieval and access to the data;
providing a cache for temporarily caching some of the data;
accessing a set of map data stored on the computer storage device, that corresponds to a digital map and that has a plurality of map items defined therein, wherein the digital map has a first map data format in which each map item is not necessarily stored or encoded using a consistent byte length; and
using a bit stream processor to performs the steps of,
while map data is being read by the system from the storage device to the memory, instead of reading it directly from disk storage to a display screen, places the map data in the memory and reads it from there, and
while the map data is subsequently by from the system to the storage device or another output, caches the map data in the cache and then writes it from the cache.

10. The method of claim 9 wherein to save overall storage requirements, the map items are stored as different byte length variables on the storage device.

11. The method of claim 9 wherein the bit stream processor provides a staging area for efficient reading and writing of map data, and also provides security for adjoining data portions that use different byte length variables.

12. The method of claim 9 wherein the bit stream processor allows an input map to be read into the system in the first map data format, and written to the output as a second or different map data format.

13. The method of claim 9 wherein the first map format is Public Sector Information (PSI) format.

14. The method of claim 14 wherein the Public Sector Information (PSI) format uses a stream of data items of various sizes from N=1 to N=32 bits and wherein the bit stream processor allows the reading and writing of N bits of data from and/or to the memory at any given bit position, without disturbing neighboring bits.

15. The method of claim 9 wherein the map data is stored on the storage device in a compressed format.

16. The method of claim 15 wherein digests the map data as it is read from the storage device, and stores the bit locations of various “memory markers” in the bit stream so that the system does not then need to start digesting the bit stream from the beginning to again determine where the area features start.
